(19) United States
(12) Patent Application Publication
(10) Pub. No.: US 2008/0159569 A1
(43) Pub. Date: Jul. 3, 2008

(54) Method and Arrangement for the Sensitive Detection of Audio Events and Use Thereof

(75) Inventor: Jens Hansen, Berlin (DE)

Correspondence Address: BORDEN LADNER GERVAIS LLP;Gail C. Silver, 1100-100 QUEEN ST, OTTAWA, ON, K1P 1J9, omitted

(73) Assignees: Jens HANSEN, Berlin (DE); Ulrich KOTTKE, Berlin (DE)

(21) Appl. No.: 11/817,704

(22) PCT Filed: Mar. 3, 2006
(86) PCT No.: PCT/DE06/00410

§ 371 Date: Sep. 28, 2007

(30) Foreign Application Priority Data
Mar. 4, 2005 (DE) 102005011358.3

(51) Int. Cl. H04R 25/00

(52) U.S. Cl. 381/151

(57) ABSTRACT

The invention relates to a method, to a device and to uses thereof for the sensitive detection of audio events in order to obtain sensations and feelings of the living skin. The audio event is broken down in to several spectral ranges, and from the signals which represent said range, control voltages are determined for a defined selection of predetermined transmitters which act upon and/or in the living skin. The selection and allocation of the control voltages is dependant on a signal analysis which uses signals which represent the spectral range. The invention relates both to the rendering of deaf people sensitive to music and to the transmission of signals to deaf people.

The method and the arrangement envision reflecting audio events as feelings or sensations on the skin. For this, excitations are transmitted onto the skin by vibrations from a vibration transmitter or by means of other transmitters. The frequency and amplitude of the vibrations with the vibration transmitter are derived from the audio event. When vibration transmitters are referred to in the following, this includes in a similar way other signal transmitters on, or into the skin.

Because the resolution of the skin as a sensory organ lies orders of magnitude below the resolution of the sense of hearing, broadband activation of only one vibration transmitter acting on the skin with the audio event is not sufficient. At best, this would lead to a certain hearing support; however, in no way on its own would this lead to an identification of the content of the sound event, thus, to a comprehension of speech. However, this is the underlying technical task of the invention.

The relatively low resolution of the skin is increased in that from every phase of the audio event—with speech, thus, from every sound—the control voltage for the vibration transmitter is formed only from the spectral range of emphasis. Highlighting the characteristic spectral features increases the recognizability of a sound.

A further increase in the identifiability occurs through a variable location of the effect of the vibration transmitter. Through this, along with the vibration amplitude and frequency, additional distinct sensible differences are attained. Thus, defined spectral ranges are allocated to defined vibration transmitters; furthermore, the number of active vibration transmitters, and thereby the breadth of effect can be varied, and finally, control of several vibration transmitters can be considered in a fast serial progression with regard to the duration of the sound, whereby the feeling arises as if a vibration transmitter moves over the skin.

The location, width, and dynamics of the effect can be significantly distinguished. A further differentiation in distinguishable effect patterns would require a concentration that is too high, and would be difficult to detect with rapidly changing speech sounds.

A dynamic compression of the audio events is also provided, through which quiet phases can be amplified so far that control voltages derived from them lead to vibrations that can be sensed.

The following allocation exists between the speech sounds and the vibration transmitters:

Voltages representing the emphasized spectral range of the vowels i, e, a, o, u each control, in the sequence mentioned, one of the vibration transmitters lying symmetrically to the right and left of center, from inside out. Therefore, vowels are perceptible according to their acoustical color from light to dark, from inside out, in a small base width.

Similarly in the center, broadband bright sibilants (s, z, ts) are perceptible, however in a larger base width.

Consonants with darker acoustical color (f, w, r, or sh) are similarly perceptible with a larger base width, however, they are perceptible farther outside.

Transiently acting broadband voiced stop consonants (b, p, g, d, q) are perceptible over the entire available base width. To increase the differentiation of these sounds, some of the vibration transmitters are activated with two separate control signals, namely, the center ones with a control voltage representing the high spectral range, the outer ones with a control voltage representing the lower spectral range.

With the nasal sounds m and n, the control voltages are supplied transiently to all vibration transmitters in a rapid serial sequence.

Whereas with “making speech sensible” the recognizability of the sounds is the decisive criterion for activation of the vibration transmitters, with the intensification of music perception, the “feeling” has priority, which results from the assimilation of the music that has been heard and felt.

If the music emphasizes the bass, i.e., the spectral emphasis is in the range less than 150 Hz, all vibration transmitters are activated with the low-pass filtered (4-pole) music signal. The emission of excitations is concentrated on the transmission of the mainly rhythmically occurring bass bursts.

With a uniform spectral distribution, or with a changing spectral emphasis, specific spectral ranges are allocated to individual groups of vibration transmitters, in such a way that with increasing tones, the vibrations are sensed symmetrically to the center of the body, from the outside in. If bursts of bass occur in lower repetition frequency, or individually on an otherwise lower bass average value, the switching of the entire vibration transmitter to low-pass characteristics occurs only for the duration of the burst.

If, with a high base average value, the energy emphasis occurs in the higher frequency range with lower repetition frequency or individually and significantly exceeds the base average value, the inner vibration transmitters are switched to the high-pass characteristic for the duration of the higher-frequency bursts.

Because the resolution of the skin in the lower frequency range is higher than in the upper frequency range, only the range up to approximately 600 Hertz is used for deriving the control voltages. Also, a somewhat higher weight is given to the bass. The control behavior is synchronous to the music. An isolated loud beat over a melodic background leads, for example, without delay and, only for the duration of the beat, to an increase in the effective width.

Another advantageous embodiment of the invention provides for analysis of the representative signals of the control voltages for the vibration transmitter, or other transmitters, in the presence of specific patterns and, when they are detected, performing a specific serial activation of the vibration transmitters. The background of this solution variant is the transmission of signal information to people who are, e.g., hearing impaired. Thus, a specific audio event can be made “audible.” Based on this, a “language” can be built.

In another advantageous embodiment of the invention, it is envisioned that the vibration transmitters are also provided with skin-exciting materials or devices that heighten the feeling or sensation of the skin.

For this, resonating needles, stimulation currents, heat impulses, or also suction actions can be used. Thus, according to the invention, feelings or sensations are to be conveyed on or into the skin in combination with vibration transmitters, or also through other such excitation providers alone. This also includes implants implanted in the skin such as acupuncture needles, whose position can be changed by electromagnetic impulses and that therefore give rise to excitations.

An example embodiment of the method will be explained using the following equipment description for vibration transmitters.

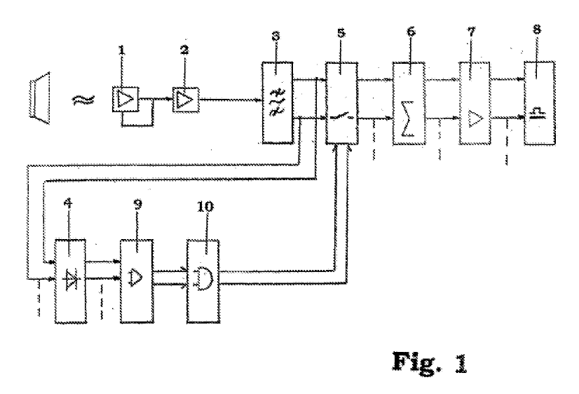

FIG. 1 shows: a circuit arrangement

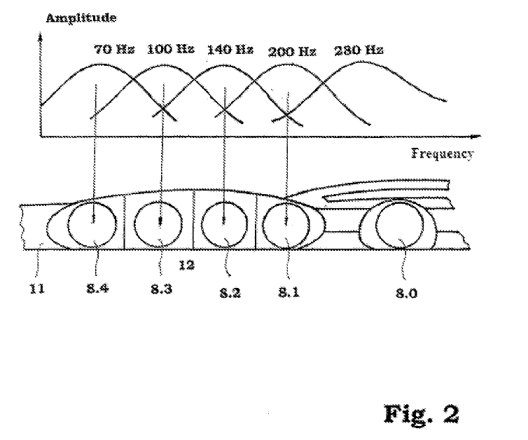

FIG. 2 shows: an allocation of frequency ranges to the vibration transmitters

The audio event, as represented as in FIG. 1, is received through a signal-receiving component 1, which can be a microphone or an adapter cable, e.g., to a sound system, to a PC or headset, or which can be a radio-operated signal receiver, and broadband amplified using an amplifier with a control circuit for dynamic compression 2. Next, the signal is divided into several spectral ranges using filter circuits 3. The output signals from the filter circuits are supplied, on the one hand, to the rectifier circuits 4 for recognition of the amplitudes, and in parallel to ten adder circuits 6, whose output signals control the vibration transmitters 8 through power amplifiers 7. This arrangement makes it possible that each vibration transmitter can be activated here with a signal of any spectral composition possible.

To control the switch matrix 5, the amplitudes of the rectified, filtered signal portions are compared using comparator circuits 9 and from the amplitude and timing relations, the control voltages for the matrix are derived using a logical combining circuit 10 according to a predetermined excitation response of the vibration transmitter.

It should be noted that it is advantageous to use a microprocessor for the functions: NF filtering, detection and comparison of amplitudes, and determination of control voltages.

FIG. 2 shows that the vibration transmitters 8 in an advantageous use of the method are arranged on the inside of a belt 11 worn around the hips, and are symmetrical to the left and right of center in the longitudinal direction of the belt 11. The various vibration transmitters 8 are allocated the frequency ranges:

8.0=above 280 Hz

8.1=181-280 Hz

8.2=121-180 Hz

8.3=71-120 Hz

8.4=up to 70 Hz,

respectively, each with a tolerance range of +25%.

The vibration transmitters 8 are arranged on the belt 11, preferably on vibration transmitter segments 12 of the belt 11, mirror-symmetrically on both sides with respect to the vibration transmitter 8.0.

### REFERENCE LIST

1 Signal-receiver component
2 Amplifier with dynamic control
3 Filter circuits
4 Rectifier circuits
5 Switch matrix
6 Adder circuits
7 Power amplifier
8 Vibration transmitter
9 Comparator circuits
10 Logical combining circuit
11 Belt
12 Vibration-transmitter support segments

1. A method for the sensitive detection of sound events, characterized in that the sound event to be detected is broken down into several spectral ranges to achieve states of feeling or sensation of the living skin, and from the signals representing these ranges, control voltages can be established for a specific selection of predetermined transmitters, which act on and/or in the living skin, wherein this selection and the allocation to the control voltages depends on a signal analysis based on the signals representing the spectral ranges.

2. A method according to claim 1, characterized in that
an allocation occurs between spectral ranges of emphasis and vibration transmitters.

3. A method according to claim 1, characterized in that
an allocation occurs between spectral ranges of emphasis and stimulation currents.

4. A method according to claim 1, characterized in that
an allocation occurs between spectral ranges of emphasis and heat-impulse transmitters.

5. A method according to claim 1, characterized in that
an allocation occurs between spectral ranges of emphasis and suction-impulse transmitters.

6. A method according to claim 1, characterized in that
different sound events are allocated different excitation characteristics of the transmitters.

7. A method according to claim 1, characterized in that
the various signals of the control voltages for the vibration transmitters or other transmitters are analyzed for the presence of predetermined patterns and, in case they are detected, a predetermined serial excitation of the transmitter occurs.

8. A method according to claim 1, characterized in that
the allocation between the characteristic spectral regions of emphasis of the sounds and the transmitters is such that for the vowels, transmitters are activated from a middle position out, in the sequence of the height of their acoustical color from bright to dark.

9. A method according to claim 1, characterized in that
the allocation between the spectral regions of emphasis characterizing the sounds and the transmitters is such that for sibilants, transmitters are activated from a central position out, in the sequence of the height of their acoustical color from bright to dark, and the number of the transmitters active with a sibilant is greater than the corresponding number of active transmitters with a vowel, in each case.

10. A method according to claim 1, characterized in that
with specific voiced stop consonants or explosive sounds, all transmitters are activated with a common control voltage, and with others, all transmitters are also activated, however, with different control voltages.

11. A method according to claim 1, characterized in that
the different activation of the transmitters with specific voiced stop consonants or explosive sounds is such that the centrally arranged transmitters are activated with a voltage that represents the higher frequency range and the outer transmitters are activated with a control voltage that represents the lower frequency range.

12. A method according to claim 1, characterized in that
with specific sounds, a fast, serial activation of all transmitters occurs in relation to the length of the sound.

13. A method according to claim 1, characterized in that
with music, the activation characteristics of the transmitters are such that with spectral emphasis points in the lower frequency range, all transmitters are activated with the low-pass filtered music signal; with uniform distribution or changing spectral emphasis points, specific transmitters are allocated to specific spectral ranges; with basses with lower repetition frequencies, all transmitters are activated with the low-pass filtered signal only for the duration of the basses; and that with a high bass average value, with the occurrence of transient spectral emphasis points in the higher frequency range, all or a portion of the transmitters are activated with the high-pass filtered music signal only for their duration.

14. An arrangement for implementing the method, with which the sound event to be detected is broken down into several spectral ranges to achieve states of feeling or sensation of the living skin, and from the signals representing these ranges, control voltages are established for a specific selection of predetermined transmitters, which act on and/or in the living skin, whereby this selection and the allocation to the control voltages depends on a signal analysis based on the signals representing the spectral ranges, consisting of components connected together by circuitry, namely, a signal-receiving component, an amplifiers with a regulating circuit for dynamic compression and broadband amplification, and a filter circuits that divides the signal into several spectral ranges, whereby the output signals from the filter circuits are supplied once to a rectifier circuit for recognition of the amplitudes, and in parallel to adder circuits (6), whose output signals control the transmitters through power amplifiers.

15. An arrangement according to claim 14, characterized in that each transmitter can be activated with a signal of any of the spectral compositions possible here.

16. An arrangement according to claim 14, characterized in that to control of the switch matrix the amplitudes of the rectified, filtered signal portions can be compared using a comparator circuits, and the control voltages for the matrix can be derived from the amplitude and timing relations, using a logical combining circuit according to a predetermined activation response of the transmitter.

17. An arrangement according to claim 14, characterized in that
the transmitters, preferably vibration transmitters, are integrated on the inner side of a belt worn around the hips.

18. An arrangement according to claim 17, characterized in that the transmitters integrated into the belt are arranged symmetrically to the left and right of the center in the longitudinal direction of the belt.

19. An arrangement according to claim 17, characterized in that the following frequency ranges, with a tolerance of +25%, are allocated from the center out to the transmitters:
8.0=above 280 Hz
8.1=181-280 Hz
8.2=121-180 Hz
8.3=71-120 Hz
8.4=up to 70 Hz.

20. An arrangement according to claim 14, characterized in that
the transmitters are vibration transmitters, stimulation currents, heat impulses, or suction-impulse transmitters or combinations thereof.

21. An arrangement according to claim 14, characterized in that
the transmitters built as vibration transmitters are provided with resonating needles whose tips are aligned against the skin or embedded in the skin.

22. An arrangement according to claim 21, characterized in that the needles are provided with additional stimulation transmitters, preferably stimulation-current conductors, optical conductors, and/or heat conductors.

23. An arrangement according to claim 14, characterized in that
the transmitter(s) act electromagnetically on the needles arranged under the skin.

24. Use of the method according to claim 1 and the arrangement according to claim 14 for reflecting audio events as state of sensation or feeling on or in human skin.

25. Use of the method according to claim 1 or the arrangement according to claim 14 for transmission of acoustic signals that are defined by content to deaf people.
